(19) United States
(12) Patent Application Publication
(10) Pub. No.: US 2025/0309695 A1
(43) Pub. Date: Oct. 2, 2025

(54) OPTICAL WIRELESS COMMUNICATION AND POWER TRANSMISSION SYSTEM FOR SPACE INTERNET AND SPACE MISSION

(71) Applicant: ELECTRONICS AND TELECOMMUNICATIONS RESEARCH INSTITUTE, Daejeon (KR)

(72) Inventors: CHAN IL YEO, Daejeon (KR); Si Woong PARK, Daejeon (KR); hyoungjun PARK, Daejeon (KR); Young Soon HEO, Daejeon (KR); Keo Sik KIM, Daejeon (KR); Kyeeun KIM, Daejeon (KR)

(21) Appl. No.: 18/915,852

(22) Filed: Oct. 15, 2024

(30) Foreign Application Priority Data
Mar. 26, 2024 (KR) 10-2024-0041023

(51) Int. Cl. H02J 50/30; H02J 50/80; H02J 50/90

(52) U.S. Cl. CPC H02J 50/30; H02J 50/80; H02J 50/90

(57) ABSTRACT

The present invention relates to an optical wireless communication and power transmission system for supporting space Internet and space missions. The optical wireless communication and power transmission system includes an optical power transmission system and an optical power receiving system. The optical power transmission system and the optical power receiving system transmit and receive mutual communication light through bi-directional optical wireless communication and form a bi-directional optical alignment link based on optical-based location recognition sensor and optical signal detector output data. The optical power transmission system can perform control so that power energy is safely transmitted to the optical power receiving system through optical wireless power transmission when the bidirectional optical alignment link meets a predetermined precision.

### CROSS-REFERENCE TO RELATED APPLICATION

This application claims priority to and the benefit of Korean Patent Application No. 10-2024-0041023, filed on Mar. 26, 2024, the disclosure of which is incorporated herein by reference in its entirety.

### BACKGROUND

### 1. Field of the Invention

The present invention relates to optical wireless communication and optical wireless power transmission technology.

### 2. Discussion of Related Art

In outer space and unexplored planets such as the Moon and Mars, it is difficult to supply power using power cables and perform high-speed data communication using wired communication networks, just like on Earth. This is because it is practically impossible to transport and install power cables and communication cables produced on Earth into space due to cost issues, and it is impossible to directly manufacture power cables and communication cables on extraterrestrial planets due to problems such as limited supply of raw materials and the cost and time required to establish production plants. Therefore, there is a need for a technology of enabling long-distance wireless power transmission to transmit power generated through power plants, such as small nuclear power and nuclear fusion power using helium-3, which are being considered to generate power in outer space and on extraterrestrial planets, including solar power, to points where power is required, and furthermore, there is a need for a technology of enabling bi-directional high-speed/large-capacity wireless data communication to perform various space missions and establish communication networks.

Unlike on Earth, in outer space, light has little loss due to absorption and scattering by particles in the atmosphere and turbulence by the atmosphere, so the usability of light is high. In optical wireless power transmission using light, divergence angle characteristics of light are reduced, so the distribution of light arriving at a destination is relatively larger than the size of a receiver during long-distance transmission, resulting in less geometric loss, and focusing is controlled through beam forming, so energy can be intensively transmitted. Optical wireless communication can transmit 1,000 times more data than radio-frequency-based wireless communication technology, can perform long-distance transmission due to excellent linearity, and can implement miniaturization and weight reduction. Recently, optical wireless communication has been attracting attention for its use in Earth orbit space communication and deep space communication. For this reason, a system capable of simultaneously performing optical wireless communication and optical wireless power transmission is an economical and effective way, and can be used to establish a space optical wireless communication network, including space Internet and data transmission mission support through high-speed/large-capacity wireless communication in outer space and on extraterrestrial planets, and to establish a space power supply network for power transmission.

In general, for wireless communication and wireless power transmission using light, precise point-to-point line-of-sight alignment between a transmission system and a receiving system is very important, and in order to simultaneously perform optical wireless communication and optical wireless power transmission, a technology or structure of matching or integrating optical axes of communication light and power transmission light to simultaneously enable optical wireless communication and optical wireless power transmission through a single process is required. Except for optical wireless communication and optical wireless power transmission between the fixed transmitting and receiving systems on surfaces of planets, satellites, space ships, orbiters, rovers, etc., which are mainly used in outer space, are all mobile. Therefore, a technology of enabling optical wireless communication and optical wireless power transmission with moving objects is required. To this end, a structure of recognizing and tracking positions, movement directions, etc., of moving objects, and establishing, maintaining, and supporting a precise line-of-sight optical alignment link is required. However, the installation of a system for establishing a separate line-of-sight optical alignment link may cause problems such as an increase in volume/weight/power consumption of the entire wireless optical communication system and optical power transmission system, an increase in system configuration complexity/difficulty, and an increase in cost. In addition, a process of matching an optical axis of a line-of-sight optical alignment system to optical wireless communication light and optical wireless power transmission light is required. For this reason, a structure and technology of simultaneously establishing a precise optical wireless communication link and an optical wireless power transmission link without a separate optical alignment system are required.

Precautions for simultaneously performing optical wireless communication and optical wireless power transmission include a structural design that prevents focused power transmission light from being incident on optical wireless communication devices and optical components or allows focused power transmission light to be incident at a critical value or less in order to prevent devices (laser, photodiodes, circuits, etc.) and optical components (lenses, optical systems, coatings, etc.) for optical wireless communication from being damaged due to power transmission light having a very high energy density per unit area. In addition, a structure of blocking harmful cosmic rays is required to reduce damage and a reduction in lifespan of optical wireless communication devices and optical components caused by harmful space rays.

Lastly, to ensure the safe operation of the high-output optical power transmission system and to prevent the high-output optical power transmission system from being damaged due to incorrect aiming, obstacle interference, etc., optical wireless power transmission needs to be begin after line-of-sight alignment between the power transmission system and the power receiving system is stably established, and when the receiving system does not receive the transmitted optical wireless energy due to interference or misalignment caused by unidentified objects or organisms entering transmission paths during optical wireless power transmission, a protection technology is required to immediately monitor this situation to stop optical wireless power transmission and ensure safety.

### SUMMARY OF THE INVENTION

The present invention is directed to providing an optical wireless communication and power transmission system that includes a structure for simultaneously performing bi-directional optical wireless optical communication and optical wireless power transmission in an effective and economical way to solve problems associated with wireless communication and wireless power transmission using light and simultaneously support space Internet and space missions, and a method of safely operating the system.

To this end, the optical wireless communication and power transmission system according to the present invention has a structure having a common optical path, enables precise line-of-sight optical alignment and tracking of moving objects using an optical wireless communication signal without a separate system for establishing a line-of-sight optical alignment link, and enables real-time monitoring and control to ensure that a high-output optical wireless power transmission process operates safely.

Objects of the present invention are not limited to the above-described objects, and other objects that are not described may be obviously understood by those skilled in the art from the following specification.

According to an aspect of the present invention, there is provided an optical wireless communication and power transmission system for supporting space Internet and space missions. The optical wireless communication and power transmission system includes an optical power transmission system and an optical power receiving system. The optical power transmission system and the optical power receiving system transmit and receive mutual communication light through bi-directional optical wireless communication and form an optical wireless communication link and an optical wireless power transmission link through a bi-directional optical alignment link based on optical-based location recognition sensor and optical signal detector output data. The optical power transmission system transmits power energy to the optical power receiving system through optical wireless power transmission when the optical wireless communication link and the optical wireless power transmission link meet a predetermined precision.

According to another aspect of the present invention, there is provided an optical power receiving system including: an optical wireless communication and tracking unit that causes a first optical signal transmitted from an optical power transmission system to be incident on an optical-based location recognition sensor to generate location data for the first optical signal; a steering unit that changes an orientation of the optical power receiving system; an integrated control unit that controls the steering unit based on the location data to form a line-of-sight optical alignment link for the optical power transmission system; and an optical power receiver that receives first power transmission light transmitted in an optical wireless manner by the optical power transmission system through the same optical path as the line-of-sight optical alignment link.

The optical wireless communication and tracking unit may perform optical wireless communication with the optical power transmission system through the same optical path as the line-of-sight optical alignment link.

The optical wireless communication and tracking unit may transmit a second optical signal to the optical power transmission system in an optical wireless manner so that the optical power transmission system may perform line-of-sight optical alignment for the optical power receiving system using the second optical signal.

The optical-based location recognition sensor may be a quadrant photodiode (QPD).

The optical wireless communication and tracking unit may acquire QPD output data for the first optical signal from the QPD, and calculate normalized X data and normalized Y data based on the QPD output data and generate the location data including the normalized X data and the normalized Y data.

The integrated control unit may determine whether the line-of-sight optical alignment link is precisely formed based on whether the QPD output data is greater than or equal to a predetermined threshold and control the optical power receiver to receive the first power transmission light through the same optical path as the line-of-sight optical alignment link when it is determined that the line-of-sight optical alignment link is precisely formed.

The integrated control unit may control the steering unit based on the location data to correct the line-of-sight optical alignment link when it is determined that the line-of-sight optical alignment link is not precisely formed.

The optical wireless communication and tracking unit may cause the first optical signal to be incident on an avalanche photodiode (APD) to generate APD output data for the first optical signal.

The integrated control unit may determine whether the line-of-sight optical alignment link is precisely formed based on whether the APD output data is greater than or equal to a predetermined threshold and control the optical power receiver to receive the first power transmission light through the same optical path as the line-of-sight optical alignment link when it is determined that the line-of-sight optical alignment link is precisely formed.

Inside the optical power receiving system, the optical power receiving system may further include a 45° tilted mirror with a hole structure to separate paths of the first optical signal and the first power transmission light.

The optical power receiving system may further include a power storage unit and an optical power transmitter. In this case, the optical power receiver may convert the first power transmission light into power and store the power in the power storage unit, and the optical power transmitter may generate second power transmission light through electrical-to-optical conversion of the power stored in the power storage unit and transmit the second power transmission light to another optical power receiving system.

According to another aspect of the present invention, there is provided an optical power transmission system, including: a power storage unit that stores power received externally; an optical wireless communication and tracking unit that causes a second optical signal transmitted from an optical power receiving system to be incident on an optical-based location recognition sensor to generate location data for the second optical signal; a steering unit that changes an orientation of the optical power transmission system; an integrated control unit that controls the steering unit based on the location data to form a line-of-sight optical alignment link for the optical power receiving system; and an optical power transmitter that generates first power transmission light through electrical-to-optical conversion of the power stored in the power storage unit and transmits the first power transmission light to the optical power receiving system in an optical wireless manner through the same optical path as the line-of-sight optical alignment link.

The optical wireless communication and tracking unit may perform optical wireless communication with the optical power receiving system through the same optical path as the line-of-sight optical alignment link.

The optical wireless communication and tracking unit may generate a first optical signal using an optical wireless communication source and transmit the first optical signal to the optical power receiving system in an optical wireless manner so that the optical power receiving system performs line-of-sight optical alignment for the optical power transmission system using the first optical signal.

The optical-based location recognition sensor may be a quadrant photodiode (QPD).

The optical wireless communication and tracking unit may acquire QPD output data for the second optical signal from the QPD, and calculate normalized X data and normalized Y data based on the QPD output data and generate the location data including the normalized X data and the normalized Y data.

The integrated control unit may determine whether the line-of-sight optical alignment link is precisely formed based on whether the QPD output data is greater than or equal to a predetermined threshold and control the optical power transmitter to transmit the first power transmission light through the same optical path as the line-of-sight optical alignment link when it is determined that the line-of-sight optical alignment link is precisely formed.

The integrated control unit may control the steering unit based on the location data to correct the line-of-sight optical alignment link when it is determined that the line-of-sight optical alignment link is not precisely formed.

The optical wireless communication and tracking unit may cause the second optical signal to be incident on an avalanche photodiode (APD) to generate APD output data for the second optical signal.

The integrated control unit may determine whether the line-of-sight optical alignment link is precisely formed based on whether the APD output data is greater than or equal to a predetermined threshold and control the optical power transmitter to transmit the first power transmission light through the same optical path as the line-of-sight optical alignment link when it is determined that the line-of-sight optical alignment link is precisely formed.

Inside the optical power transmission system, the optical power transmission system may further include a 45° tilted mirror with a hole structure that is disposed to transmit the first power transmission light and the first optical signal incident in a direction perpendicular to an incident direction of the first power transmission light to the optical power receiving system through the same optical path as the line-of-sight optical alignment link.

According to another aspect of the present invention, there is provided a method of operating an optical power transmission system, including: causing a second optical signal transmitted from an optical power receiving system to be incident on an optical-based location recognition sensor to generate location data for the second optical signal; adjusting an orientation of the optical power transmission system based on the location data to form a line-of-sight optical alignment link between the optical power transmission system and the optical power receiving system; and generating first power transmission light by electrical-to-optical conversion of pre-stored power and transmitting the first power transmission light to the optical power receiving system in an optical wireless manner through the same optical path as the line-of-sight optical alignment link.

According to the present invention, it is possible to simultaneously perform low-loss/long-distance bi-directional optical wireless communication and optical wireless power transmission in a space environment.

According to the present invention, by enabling optical wireless power transmission while performing bi-directional optical wireless communication and optical alignment/tracking for a fixed or mobile system in outer space and on extraterrestrial planets in an economical and effective way, it is possible to establish a ultrahigh-speed/large-capacity space Internet communication network and establish a power supply network to support various space missions.

In addition, the present invention provides a method of monitoring and controlling a transmission path state in real time so that high-output optical wireless power transmission can be safely performed.

Effects which can be achieved by the present invention are not limited to the above-described effects. That is, other effects that are not described may be obviously understood by those skilled in the art to which the present invention pertains from the following description.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a bi-directional optical wireless communication and unidirectional optical power transmission system according to an embodiment of the present invention;

FIG. 2 is a block diagram illustrating a configuration of a bi-directional optical wireless communication and bi-directional optical power transmission system according to an embodiment of the present invention;

FIG. 3 is a structural diagram of a bi-directional optical wireless communication and unidirectional optical power transmission system according to an embodiment of the present invention;

FIGS. 4A and 4B are structural diagrams of an optical power transmission system and an optical power receiving system having a bi-directional optical wireless communication structure in which an optical wireless communication transmitter is separated according to an embodiment of the present invention;

FIGS. 5A, 5B, 5C, 5D, 5E and 5F are structural diagrams of a unidirectional optical power transmission system in which an optical wireless communication subsystem is separated according to an embodiment of the present invention;

FIG. 6 is a diagram illustrating a change in system structure according to a change in shapes of a primary mirror and a secondary mirror;

FIG. 7 is a structural diagram of a bi-directional optical wireless communication and bi-directional optical power transmission system according to an embodiment of the present invention;

FIG. 8 is a flowchart illustrating a method of operating an optical power transmission system according to an embodiment of the present invention;

FIG. 9 is a flowchart illustrating a method of operating an optical power receiving system according to an embodiment of the present invention; and

FIG. 10 is a block diagram illustrating a computer system for implementing the method according to the embodiment of the present invention.

### DETAILED DESCRIPTION OF EXEMPLARY EMBODIMENTS

The present invention relates to an optical wireless communication and optical power transmission system. Specifically, the present invention relates to an optical wireless communication and power transmission system capable of wireless power transmission to support various missions, such as bi-directional high-speed, large-capacity wireless data communication, space exploration, and establishing a space power supply network, using light to support space Internet, communication and information transmission.

Various advantages and features of the present invention and methods accomplishing them will become apparent from the following description of embodiments with reference to the accompanying drawings. However, the present invention is not limited to exemplary embodiments to be described below, may be implemented in various different forms, these embodiments will be provided only in order to make the present invention complete and allow those skilled in the art to completely recognize the scope of the present invention, and the present invention will be defined by the scope of the claims. Meanwhile, terms used in the present specification are for describing exemplary embodiments rather than limiting the present invention. Unless otherwise stated, a singular form includes a plural form in the present specification. “Comprise” and/or “comprising” used in the present invention indicate(s) the presence of stated components, steps, operations, and/or elements but do(es) not exclude the presence or addition of one or more other components, steps, operations, and/or elements.

Terms used in the specification, “first,” “second,” etc., may be used to describe various components, but the components are not to be interpreted as limited by the terms. These terms may be used to differentiate one component from other components. For example, a “first” component may be named a “second” component and a “second” component may also be similarly named a “first” component, without departing from the scope of the present invention.

It is to be understood that when a first element is referred to as being “connected to” or “coupled to” a second element, the first element may be directly connected or coupled to the second element or may be connected to or coupled to the second element with another element interposed therebetween. On the other hand, it should be understood that when a first element is referred to as being “directly connected to” or “directly coupled to” a second element, the first element may be connected to or coupled to the second element without another element interposed therebetween. In addition, other expressions describing a relationship between components, that is, “between,” “directly between,” “neighboring to,” “directly neighboring to” and the like, should be similarly interpreted.

When it is decided that the detailed description of related known technology may unnecessary obscure the gist of the present invention, a detailed description thereof will be omitted.

Hereinafter, embodiments of the present invention will be described in detail with reference to the accompanying drawings. In order to facilitate overall understanding of the present invention in describing the present invention, the same means will be denoted by the same reference numerals regardless of drawing numbers.

The present invention relates to an optical wireless communication and power transmission system capable of simultaneously performing bi-directional wireless data communication and wireless power transmission in outer space and on extraterrestrial planets to establish a wireless communication network for supporting ultrahigh-speed, high-capacity space Internet and a wireless power supply network for supporting space missions, and a method of safely operating the system.

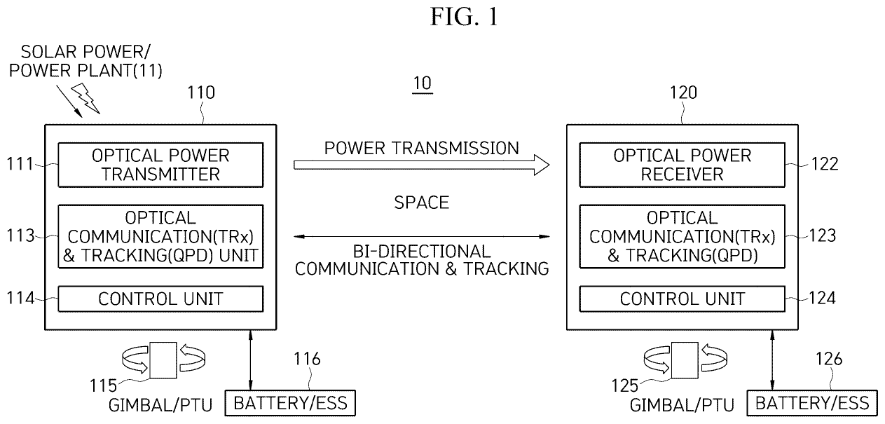

FIG. 1 is a block diagram illustrating a configuration of a bi-directional optical wireless communication and unidirectional optical power transmission system according to an embodiment of the present invention.

FIG. 1 illustrates a configuration and operating concept of a system capable of simultaneously enabling bi-directional optical wireless communication and unidirectional optical wireless power transmission.

As illustrated in FIG. 1, a bi-directional optical wireless communication and unidirectional optical power transmission system 10 according to the embodiment of the present invention includes an optical power transmission system 110 and an optical power receiving system 120. The optical power transmission system 110 includes an optical power transmitter 111, an optical wireless communication and tracking unit 113, an integrated control unit 114, a steering unit 115, and a power storage unit 116, and the optical power receiving system 120 includes an optical power receiver 122, an optical wireless communication and tracking unit 123, an integrated control unit 124, a steering unit 125, and a power storage unit 126.

The optical power transmission system 110 receives power generated by various power plants 11, such as small nuclear power and nuclear fusion power using helium-3, including solar power, in space and on extraterrestrial planets. The optical power transmission system 110 may receive power from a power plant 11 through a wired supply network. The optical power transmission system 110 may store power transmitted from the power plant 11 in the power storage unit 116 or immediately transmit the stored power to the optical power receiving system 120. The optical power transmission system 110 performs bi-directional optical wireless communication between the two systems 110 and 120 and tracking of the other system, including precise line-of-sight optical alignment, simultaneously with performing optical wireless power transmission to the optical power receiving system 120. Through this method, it is possible to establish an ultrahigh-speed, high-capacity optical wireless communication network such as space Internet service.

Specifically, the optical wireless communication and tracking units 113 and 123 perform bi-directional optical wireless communication between the two systems 110 and 120 and the tracking of the other system, including precise line-of-sight optical alignment. The optical power transmitter 111 performs optical wireless power transmission of the power received from the power plant 11 to the optical power receiver 122 after bi-directional precision line-of-sight optical alignment between the two systems 110 and 120 is completed.

The optical power transmission system 110 or the optical power receiving system 120 includes the power storage units 116 and 126 for storing the generated power or received power. For example, the power storage units 116 and 126 may be batteries or energy storage systems (ESS).

In addition, the optical power transmission system 110 or the optical power receiving system 120 includes the optical wireless communication and tracking units 113 and 123, the integrated control units 114 and 124, and the steering units 115 and 125.

The optical wireless communication and tracking units 113 and 123 generate built-in optical-based location recognition sensor (quadrant photodiode (QPD)) and optical signal detector (avalanche photodiode (APD)) output data. The integrated control units 114 and 124 control the steering units 115 and 125 based on the QPD output data and the APD output data or instructs movement of a moving object (refers to a moving object equipped with the optical power transmission system 110 or the optical power receiving system 120) to perform precise line-of-sight optical alignment and tracking and bi-directional optical wireless communication. In addition, the optical wireless communication and tracking units 113 and 123 may further include a fast/fine steering mirror (FSM) (not illustrated) inside thereof to improve the accuracy of line-of-sight optical alignment and tracking and communication performance.

An embodiment in which the optical wireless communication and tracking units 113 and 123 and the integrated control units 114 and 124 perform precise line-of-sight optical alignment and tracking based on QPD output data may have the following two types depending on whether the optical wireless communication and tracking units 113 and 123 include a calculation function.

The first embodiment is a case where the optical wireless communication and tracking units 113 and 123 include a calculation function of QPD sum, normalized X data, and normalized Y data. The optical wireless communication and tracking units 113 and 123 use an optical-based location recognition sensor (QPD) to generate the QPD output data. The QPD output data includes Q1 output data, Q2 output data, Q3 output data, and Q4 output data. The optical wireless communication and tracking units 113 and 123 generate the QPD sum, the normalized X data, and the normalized Y data based on the QPD output data. In addition, the optical wireless communication and tracking units 113 and 123 transmit the QPD sum, the normalized X data, and the normalized Y data to the integrated control units 114 and 124, and the integrated control units 114 and 124 analyze the QPD sum, the normalized X data, and the normalized Y data to control the steering units 115 and 125 or instruct the movement of a moving object (refers to a moving object equipped with the optical power transmission system 110 or the optical power receiving system 120).

For reference, in this specification, the normalized X data and the normalized Y data are referred to as ‘location data’.

The second embodiment is a case where the optical wireless communication and tracking units 113 and 123 does not include the calculation function of the QPD sum, the normalized X data, and the normalized Y data. In this case, the integrated control units 114 and 124 are responsible for calculating the QPD sum, the normalized X data, and the normalized Y data. The optical wireless communication and tracking units 113 and 123 generate the QPD output data and transmit the generated QPD output data to the integrated control units 114 and 124. The integrated control units 114 and 124 generate the QPD sum, the normalized X data, and the normalized Y data based on the QPD output data. The integrated control units 114 and 124 analyze the QPD sum, the normalized X data, and the normalized Y data to control the steering units 115 and 125 or instruct the movement of a moving object (refers to the moving object equipped with the optical power transmission system 110 or the optical power receiving system 120).

The steering units 115 and 125 change the direction (angle) of the optical power transmission system 110 or the optical power receiving system 120 under the control of the integrated control units 114 and 124, thereby enabling line-of-sight optical alignment and tracking, bi-directional optical and wireless communication links, and establishment of an optical and wireless power transmission path. The steering units 115 and 125 may include a gimbal and/or a pan and tilt unit (PTU).

The integrated control units 114 and 124 operate the power storage units 116 and 126 and control the steering units 115 and 125. The integrated control units 114 and 124 control a horizontal angle (azimuth or pan) or a vertical angle (elevation or tilt) of the gimbal or PTU included in the steering units 115 and 125. In addition, the integrated control units 114 and 124 translates (or displaces) the optical power transmission system 110 or the optical power receiving system 120 in the horizontal or vertical direction. The translation of the optical power transmission system 110 or the optical power receiving system 120 may be implemented by moving a moving object equipped with the optical power transmission system 110 or the optical power receiving system 120. The moving object refers to a moving object equipped with the systems 110 and 120. For example, the moving object may be a satellite, spacecraft, orbiter, rover, mobile infrastructure, etc. The present invention does not impose any restrictions on the type of moving objects.

In addition, the integrated control units 114 and 124 control the precise line- of-sight optical alignment and tracking and the bi-directional optical wireless communication through the optical wireless communication and tracking units 113 and 123. In addition, the integrated control units 114 and 124 comprehensively control safe optical wireless power transmission by monitoring the line-of-sight optical alignment link formation state and optical wireless power transmission path state.

The optical-based location recognition sensor (QPD) is physically divided into four areas: Q1 (first quadrant), Q2 (second quadrant), Q3 (third quadrant), and Q4 (fourth quadrant), etc. For reference, based on the coordinate plane, Q1 is an area where X>0 and Y>0, Q2 is an area where X<0 and Y>0, Q3 is an area where X<0 and Y<0, and Q4 is an area where X>0 and Y<0. The optical alignment using the QPD uses the QPD sum, the normalized X data, and the normalized Y data.

The QPD sum is the sum (Q1+Q2+Q3+Q4) of the QPD output data Q1, Q2, Q3, and Q4. The location data (normalized X data and normalized Y data) are each obtained by a calculation such as {((Q1+Q4)−(Q2+Q3))/Sum} and {((Q1+Q2)−(Q3+Q4))/Sum}. The optical wireless communication and tracking units 113 and 123 use an optical-based location recognition sensor (QPD) to acquire the QPD output data. The optical wireless communication and tracking units 113 and 123 or the integrated control units 114 and 124 generate the QPD sum, the normalized X data, and the normalized Y data based on the QPD output data. The integrated control units 114 and 124 determine the movement amount in the X-and Y-axis directions of the optical power transmission system 110 or the optical power receiving system 120 based on the normalized X data and the normalized Y data and control the steering units 115 and 123 or move the optical power transmission system 110 and/or the optical power receiving system 120 based on the movement amount to form precise line-of-sight optical alignment or correct a distortion of a pre-formed line-of-sight optical alignment link. In general, a target that the optical power transmission system 110 or the optical power receiving system 120 changes a direction or translates is itself, but when the optical power transmission system 110 or the optical power receiving system 120 may monitor the other party's data (for example, QPD output data or location data) through the optical wireless communication, a target of the directional control or translation may be not only itself but also the other system. When an angle needs to change, it is preferable to control the other system, and when movement is necessary, it is preferable to move oneself. This is because when its own angle changes, it may have a great impact on the other party, and when the other party moves, it may also affect the angle.

The present invention has the advantage of enabling precise line-of-sight optical alignment and tracking based on a portion of the communication light used for bi-directional optical wireless communication, the optical-based location recognition sensor output data, and the Gbps-level high-speed/large-capacity bi-directional optical wireless communication optical signal detector (APD) output data without a separate optical alignment light source, optical components, and system for line-of-sight alignment. In addition, by transmitting and receiving the light for optical wireless communication and the light for optical wireless power transmission through the same optical axis and optical path, it is possible to establish a path for optical wireless power transmission while forming a bi-directional optical wireless communication link using the optical wireless communication light, and by determining whether to form the optical wireless power transmission path and performing state monitoring based on the bi-directional optical wireless communication signal strength, it is possible to enable safe operation, such as starting and stopping the optical wireless power transmission.

As described above, the integrated control units 114 and 124 generate the QPD sum and location data based on the optical-based location recognition sensor (QPD) and optical signal detector (APD) output data, or analyze the QPD sum, the location data, and the optical signal detector (APD). In order to form and track a bi-directional line-of-sight optical alignment link, based on the analysis results, the integrated control units 114 and 124 control the steering units 115 and 125 or control the FSM inside the optical wireless communication and tracking units 113 and 123. When it is confirmed that the bi-directional line-of-sight optical alignment link has been precisely formed, the integrated control units 114 and 124 control the optical wireless communication and tracking units 113 and 123, the optical power transmitter 111, and the optical power receiver 122 to perform bi-directional optical wireless communication and optical wireless power transmission through the line-of-sight optical alignment link. That is, when it is confirmed that the bi-directional line-of-sight optical alignment link has been precisely formed, the integrated control units 114 and 124 open the bi-directional optical wireless communication link and the optical wireless power transmission path. In addition, the integrated control units 114 and 124 monitor the status of the pre-formed optical wireless power transmission path or control the power storage units 116 and 126. To this end, the integrated control units 114 and 124 perform real-time monitoring and control of the steering units 115 and 125 to form and maintain the bi-directional optical wireless communication link and the optical wireless power transmission path with the fixed or mobile system through bi-directional precision line-of-sight optical alignment and dynamic tracking based on the optical output data (QPD sum) or location data (normalized X data, normalized Y data) received by the optical wireless communication and tracking units 113 and 123, and support to safely perform long-distance (hundreds to thousands of km) bi-directional optical wireless communication and optical wireless power transmission in outer space, including extraterrestrial planets by sequentially monitoring the optical location recognition sensor (QPD) and optical wireless communication optical signal detector (APD) output data.

Specifically, when the optical-based location recognition sensor (QPD) output data and optical signal detector (APD) output data of the optical wireless communication and tracking units 113 and 123 is received at a threshold or greater, the integrated control units 114 and 124 determine that a bi-directional optical alignment link has been precisely formed to start optical wireless power transmission. For example, when all of the QPD output data Q1, Q2, Q3, and Q4 are greater than or equal to a predetermined threshold or the QPD sum is greater than or equal to a predetermined threshold, the integrated control units 114 and 124 determine that the line-of-sight optical alignment link has been precisely formed and start optical wireless power transmission along the same optical path as the link. The output of power transmitted from the optical power transmission system 110 is controlled by the integrated control unit 114 or the optical power receiving system 120. The optical power receiving system 120 transmits a control command to the optical power transmission system 110 or the integrated control unit 114 via the optical wireless communication link to increase/decrease/maintain the power output from the optical power transmission system 110 based on optical-to-electrical conversion output data.

Meanwhile, since abnormal situations such as misalignment, misaiming, and fading by obstacles occur between the optical power transmission system 110 and the optical power receiving system 120 during optical wireless power transmission, when it is determined that the optical signal detector (APD) output data or the optical-based location recognition sensor (QPD) output data of the optical wireless communication and tracking unit 113 inside the optical power transmission system 110 is received below the threshold or the bi-directional communication link is disconnected, the integrated control unit 114 controls the optical power transmission system 110 to enable safe optical wireless power transmission.

In addition, for the same reason, when the optical signal detector (APD) output data or the optical-based location recognition sensor (QPD) optical output data of the optical wireless communication and tracking unit 123 inside the optical power receiving system 120 is received below the threshold, the bi-directional communication link is determined to be disconnected, or the optical-to-electrical conversion output data of the optical power receiving system 120 decreases to below a reference value, the integrated control unit 124 of the optical power receiving system 120 transmits control and situation information to the optical power transmission system 110 through the optical wireless communication and tracking unit 123. In this case, the integrated control unit 114 of the optical power transmission system 110 controls the optical power transmission system 110 to safely perform optical wireless power transmission.

For example, the integrated control unit 114 may perform control the power transmission of the optical power transmitter 111 to stop when the optical signal detector (APD) output data or the optical-based location recognition sensor (QPD) output data of the optical wireless communication and tracking unit 113 is less than or equal to the threshold or based on the situation information received by the optical power receiving system 120, and may initiate the power transmission procedure again after correcting (or reforming) the bi-directional line-of-sight optical alignment link while determining the bi-directional link formation precision based on the optical signal detector (APD) output data or the optical-based location recognition sensor (QPD) output data.

Meanwhile, the optical wireless communication and tracking units 113 and 123 perform transmission and reception of optical wireless data. In this specification, optical wireless data refers to data included in optical signals exchanged between the optical power transmission system 110 and the optical power receiving system 120. That is, the optical wireless communication and tracking unit 113 and the optical wireless communication and tracking unit 123 perform optical wireless data communication with each other and transmit the received data to the integrated control units 114 and 124.

In addition, the optical wireless communication and tracking units 113 and 123 transmit the QPD output data to the integrated control units 114 and 124 to perform line-of-sight optical alignment and dynamic tracking. The optical wireless communication and tracking units 113 and 123 transmit the APD output data to the integrated control units 114 and 124, thereby enabling more precise line-of-sight optical alignment than when using the QPD output data alone. The integrated control units 114 and 124 are capable of detecting the movement direction of the optical power transmission system 110 and the optical power receiving system 120 based on the QPD sum (intensity) and/or the location data (normalized X data and normalized Y data), but are capable of detecting only the output intensity based on the APD output data. Therefore, the APD output data is only used to determine bi-directional link formation precision.

As described above, the integrated control units 114 and 124 analyze the QPD output data (or QPD sum and location data) and APD output data received from the optical wireless communication and tracking units 113 and 123 and control the steering unit to form the line-of-sight optical alignment link, or move the moving object equipped with the systems 110 and 120, and perform precise control using the FSM included inside the optical wireless communication and tracking units 113 and 123 to improve line-of-sight optical alignment and tracking accuracy and communication performance.

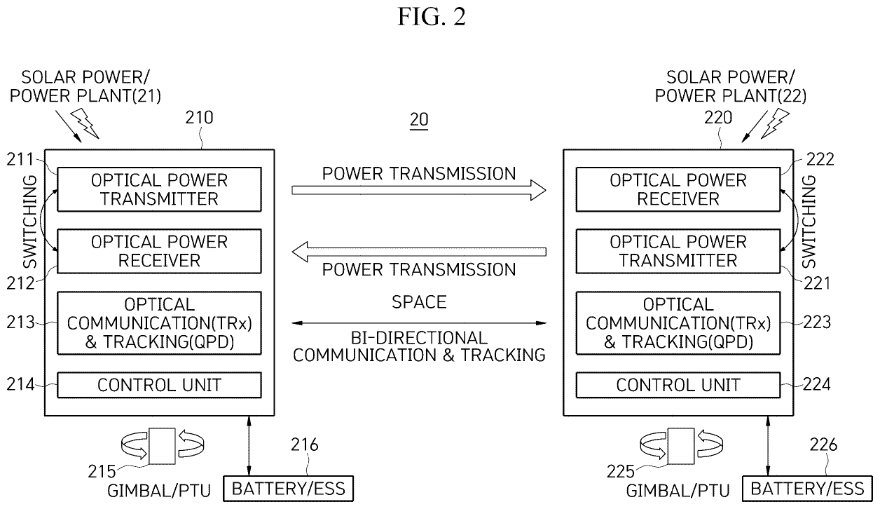

FIG. 2 is a block diagram illustrating a configuration of a bi-directional optical wireless communication and bi-directional optical power transmission system according to an embodiment of the present invention. FIG. 2 illustrates a configuration and operating concept of a system capable of simultaneously enabling bi-directional optical wireless communication and bi-directional optical wireless power transmission.

As illustrated in FIG. 2, the bi-directional optical wireless communication and bi-directional optical power transmission system 20 according to the embodiment of the present invention includes two optical power transceivers 210 and 220.

As illustrated in FIG. 2, the configurations of the two optical power transceivers 210 and 220 are the same.

The optical power transceivers 210 and 220 each include optical power transmitters 211 and 221, optical power receivers 212 and 222, optical wireless communication and tracking units 213 and 223, integrated control units 214 and 224, steering units 215 and 225, and power storage units 216 and 226.

Compared to the optical power transmission system 110 or the optical power receiving system 120 illustrated in FIG. 1, the optical power transceivers 210 and 220 include both the optical power transmitters 211 and 221 and the optical power receivers 212 and 222 and have the additional feature of being capable of switching between transmitters and receivers. That is, the optical power transceivers 210 and 220 may perform all the functions performed by the optical power transmission system 110 or the optical power receiving system 120 illustrated in FIG. 1, and may be a transmitter and receiver in optical wireless power transmission. The functions of the optical wireless communication and tracking units 213 and 223, the integrated control units 214 and 224, the steering units 215 and 225, and the power storage units 216 and 226 are the same as the functions of the components of the same name included in the optical power transmission system 110 or the optical power receiving system 120 illustrated in FIG. 1.

The optical power transceivers 210 and 220 can simultaneously perform bi-directional optical wireless communication and bi-directional optical wireless power transmission by adding some devices (optical power transmitter or optical power receiver), changing the structure, and adding control functions. In this case, when one system has a structure capable of both optical wireless power transmission and reception, including bi-directional optical wireless communication, the integrated control units 214 and 224 may control switching control units 217 and 227 (not illustrated) according to the role of the optical power transmission system or the optical power receiving system to supply power through optical wireless power transmission from a day area, where solar power is possible, to a night area, where solar power is not possible, so it is possible to establish a power grid that can supply power from areas where solar power is possible to areas where solar power is not possible, regardless of the position of the sun, and it is possible to constantly transmit power from a system with a high power charging amount or power production amount to a system with insufficient power.

In addition, the optical power transceivers 210 and 220 may determine which of the two systems 210 and 220 will transmit power and which of the two systems 210 and 220 will receive power through bi-directional optical wireless communication.

In addition, when point-to-point optical wireless power transmission is difficult from a power source to a destination due to obstacles/interference, etc., the bi-directional optical wireless communication and bi-directional optical power transmission system 20 enables optical wireless power transmission through the source-relay-destination path by forming an alternative path and relaying power to a final destination. For example, when there are three optical power transceivers 210-1, 210-2, and 210-3 identical to the optical power transceiver 210, the second optical power transceiver 210-2 may transmit the power received from the first optical power transceiver 210-1 to the third optical power transceiver 210-3. In addition, even when the distance between the source and the destination is very long such as in deep space, and the optical wireless power transmission efficiency is low due to geometric optical loss, etc., there is an advantage in that optical wireless power transmission to the source-multiple relays-destination path through the multiple relays is possible.

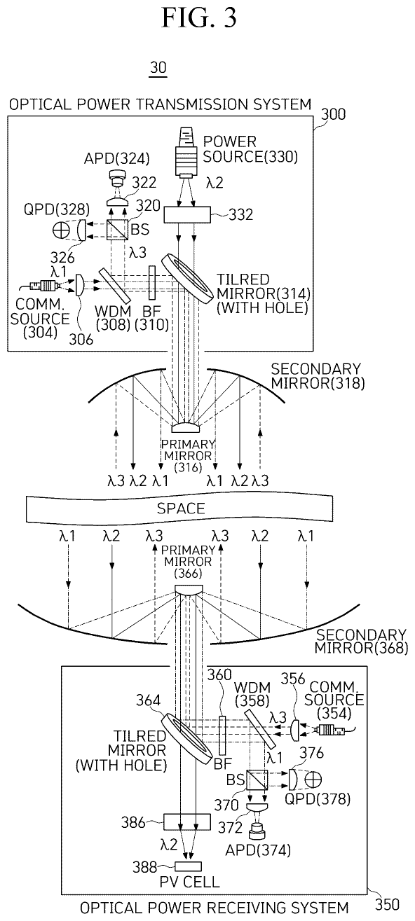

FIG. 3 is a structural diagram of a bi-directional optical wireless communication and unidirectional optical power transmission system according to an embodiment of the present invention. FIG. 3 illustrates a structure of a system for simultaneously performing bi-directional optical wireless communication and unidirectional optical wireless power transmission.

The bi-directional optical wireless communication and unidirectional optical power transmission system 30 illustrated in FIG. 3 includes an optical power transmission system 300 and an optical power receiving system 350.

The optical power transmission system 300 simultaneously uses an optical signal λ1 for optical wireless communication and line-of-sight optical alignment. The optical signal λ1 sequentially passes through wavelength division multiplexing 308 and a bandpass filter (BF) 310 via an optical system 306 for collimated beam formation from an optical wireless communication source 304, is reflected from a reflective surface of a 45° tilted mirror 314 with a hole structure, and is finally transmitted to the optical power receiving system 350 through reflection by a primary mirror 316 and a secondary mirror 318 along the same optical axis and common optical path as λ2 which is light for energy transmission.

The optical power transmission system 300 uses light λ2 (hereinafter referred to as ‘power transmission light’) to transmit power energy.

The power transmission light λ2 is output from a power source 330 by electrical-to-optical conversion, passes through a perforated hole portion of a 45° tilted mirror with a hole structure via an optical system 332 for collimated beam formation, is sequentially reflected by the primary mirror 316 and the secondary mirror 318, and is finally transmitted to the optical power receiving system 350.

The optical power receiving system 350, which is the opposite system of the optical power transmission system 300, simultaneously uses an optical signal λ3 for the purposes of optical wireless communication and line-of-sight optical alignment.

The process by which the optical power transmission system 300 receives the optical signal λ3 output from the optical power receiving system 350 will be described below. The optical signal λ3 is reflected from the reflective surface of the 45° tilted mirror 314 with a hole structure via the secondary mirror 318 and the primary mirror 316, branched depending on transmittance and reflectance values of a beam splitter (BS) 320 by sequentially passing through the BF 310, the WDM 308, and the BS 320, and incident on an optical signal detector (APD) 324 for optical wireless data communication and an optical-based location recognition sensor (QPD) 328 for line-of-sight optical alignment and dynamic tracking. When the optical power transmission system 300 and the optical power receiving system 350 are used as fixed types or an active area of the optical signal detectors (APD) 324 and 374 and the optical-based location recognition sensors (QPD) 328 and 378 is very small, the optical systems 322, 326, 372, and 376 are generally designed and used for focusing received light. However, when the optical power transmission system 300 and the optical power receiving system 350 are used as mobile types, the optical systems 322, 326, 372, and 376 are designed to reduce perturbations due to movement by forming a collimated beam and may be built into the systems 300 and 350.

BS transmittance and reflectance can be adjusted and applied depending on the importance or purpose of optical wireless communication, line-of-sight optical alignment, and dynamic tracking. In addition, the optical signal detector (APD) 324 and the optical-based location recognition sensor (QPD) 328, which are used for optical wireless communication and line-of-sight optical alignment and dynamic tracking, can be relocated, such as by exchanging positions, depending on the system configuration and internal space arrangement.

Meanwhile, the BF 310 transmits λ1 and λ3 wavelengths for simultaneously performing bi-directional optical wireless communication and optical alignment, and preferably has a coating, polarization or reflection structure, or a metasurface that has properties of blocking the optical wireless power transmission light λ2 with high energy density to prevent the optical devices (APD, QPD, laser, etc.) and circuits from being damaged and blocking the optical devices (APD, QPD, laser, etc.) and circuits from being disabled due to incorrect APD and QPD output and saturation phenomena.

The process by which the optical power receiving system 350 receives the optical signal λ1 and the optical wireless power transmission light λ2 will be described below. The optical signal λ1 and the optical wireless power transmission light λ2 for optical wireless communication and line-of-sight optical alignment, which are transmitted from the optical power transmission system 300, are incident into the inside of the optical power receiving system 350 through the reflection of a secondary mirror 368 and a primary mirror 366 along the common optical path.

The optical signal λ1 is reflected through a 45° tilted mirror 364 with a hole structure, incident on an optical signal detector (APD) 374 and an optical-based location recognition sensor (QPD) 378 depending on the transmittance and reflectance of the BS 370 by sequentially passing through the BF 360, the WDM 358, and the BS 370, and used for optical wireless communication and line-of-sight optical alignment and dynamic tracking.

The optical wireless power transmission light λ2 passes through the hole structure of the 45° tilted mirror 364, passes through an optical system 386 for focusing, and is finally subjected to optical-to-electrical conversion in an optical-to-electrical conversion device (photovoltaic device (PV) 388).

The optical power receiving system 350 uses the communication source 354 to transmit the optical signal λ3 to the optical power transmission system 300 on the opposite side for optical wireless communication and line-of-sight optical alignment and dynamic tracking. The optical signal λ3 is reflected from the reflective surface of the 45° tilted mirror 364 with a hole structure by sequentially passing through the optical system 356, the WDM 358, and the BF 360 to form a collimated beam, and is finally transmitted to the optical power transmission system 300 through the reflection process by the secondary mirror 368.

The BF 360 used by the optical power receiving system 350 transmits the optical signals λ1 and λ3 for bi-directional optical wireless communication, as described in the above description of the optical power transmission system 300, and preferably has a coating, a polarization or reflection structure, or a metasurface so as to have the property of blocking the light λ2 for optical wireless power transmission.

The transmittance and reflectance of the BS 370, the role of the optical systems 372 and 376, and the arrangement of the optical wireless communication receiver (APD) 374 and the optical-based location recognition sensor (QPD) 378 can also be adjusted as needed in the same manner as the above description of the optical power transmission system 300.

The 45° tilted mirrors 314 and 364 with a hole structure can adjust the pass rate and reflection rate by expanding or reducing the reflective surface depending on the importance of bi-directional optical wireless communication and optical wireless power transmission, and is capable of fine angle control through the integrated control units 114 and 124 to perform the role of the FSM. Contrary to the embodiment illustrated in FIG. 3, the optical power receiving system 350 may have a structure that reflects the optical wireless power transmission light λ2 and passes the bi-directional optical wireless communication and line-of-sight optical alignment light λ1 and λ3 by changing the locations of optical power receiving subsystems (system including 386 and 388) and subsystems (systems including 354, 356, 358, 360, 370, 372, 374, 376, and 378) for optical wireless communication and line-of-sight optical alignment. In addition, the 45° tilted mirrors 314 and 364 with a hole structure may have various shapes, such as circular, oval, square, polygonal, straight, and cross-shaped.

The primary mirrors 316 and 366 and the secondary mirrors 318 and 368 may have various shapes including parabolic, Cassegrain, Gregorian, convex, and concave, but are not limited thereto, and preferably have a structure that transmits the transmitted light over a long distance along the same optical axis through reflection or focuses the received light into the optical-to-electrical conversion device (PV cell), the APD/QPD, etc., and allows the received light to be incident.

It is preferable that the optical signals λ1 and λ3 for optical wireless communication and the light λ2 for optical wireless power transmission have different wavelengths. Specifically, it is preferable that the optical signals λ1 and λ3 for optical wireless communication have an infrared band wavelength including 1,550 nm, which has low propagation loss in outer space, and it is preferable that the light λ2 for optical wireless power transmission has a different wavelength from the optical signal for optical wireless communication and has high optical-to-electrical conversion efficiency in the optical-to-electrical conversion device (PV) and has a wavelength (800-1,000 nm near-infrared band) with low loss in outer space.

In addition, it is preferable that optical components, mirrors, etc., used in outer space and extraterrestrial planets have a coating, a polarization or reflection structure, and a metasurface that prevents harmful cosmic rays from being incident into the inside of the system and adversely affecting internal optical devices and circuits.

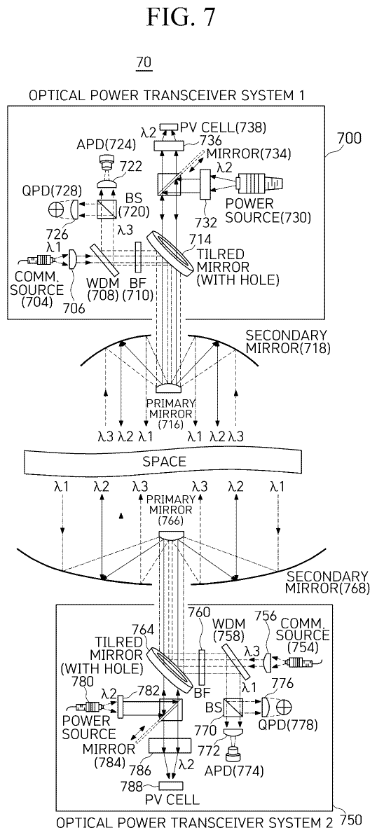

In the optical power transmission system 300 or the optical power receiving system 350, the portions related to the transmission and reception of the optical signals λ1 and λ3 used for optical wireless communication and line-of-sight optical alignment are included in the optical wireless communication and tracking units 113 and 123, and the portion related to the transmission and reception of power transmission light λ2 is included in the optical power transmitter 111 or the optical power receiver 122. This inclusion relationship is the same in the drawings below, and also applies to the bi-directional optical wireless communication and bi-directional optical power transmission system of FIG. 2. For example, in FIG. 7, the portions related to the transmission and reception of the optical signals λ1 and λ3 used for optical wireless communication and line-of-sight optical alignment are included in the optical wireless communication and tracking units 213 and 223, and the portion related to the transmission of the power transmission light λ2 is included in the optical power transmitters 211 and 221, and the portion related to the reception of the power transmission light λ2 is included in the optical power receivers 212 and 222.

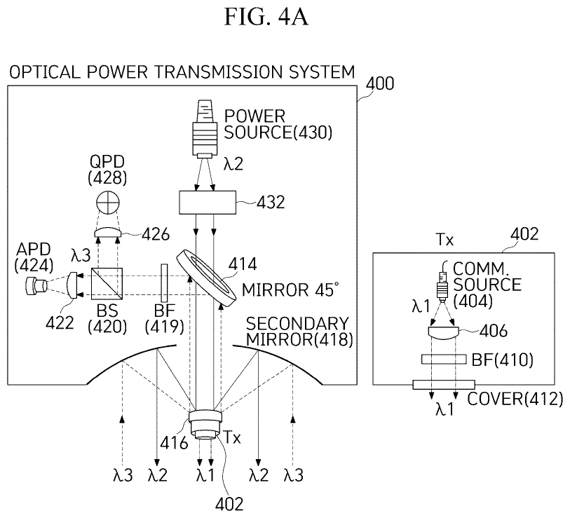

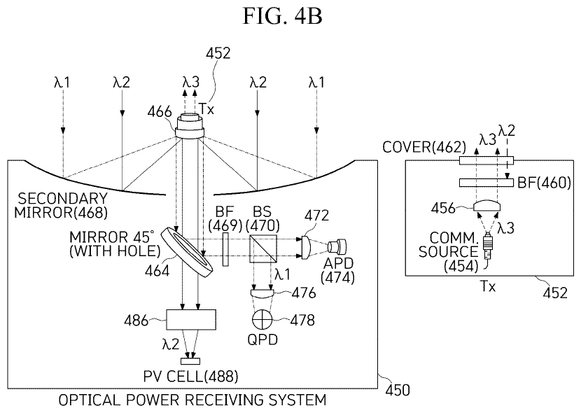

FIGS. 4A and 4B are structural diagrams of an optical power transmission system and an optical power receiving system having a bi-directional optical wireless communication structure in which an optical wireless communication transmitter is separated according to an embodiment of the present invention. FIG. 4A illustrates a structure of an optical power transmission system 400 having a bi-directional optical wireless communication structure in which an optical wireless communication transmitter (Tx) 402 is separated, and FIG. 4B illustrates a structure of an optical power receiving system 450 having a bi-directional optical wireless communication structure in which an optical wireless communication transmitter (Tx) 452 is separated.

The optical power transmission system 400 illustrated in FIG. 4A has a structure in which an optical wireless communication transmitter (Tx) 402 is separated. The optical power transmission system 400 is a system capable of simultaneously enabling bi-directional optical wireless communication and optical wireless power transmission, and the transmitter (Tx) 402 of the optical signal λ1 for optical wireless communication and line-of-sight optical alignment is provided on the opposite side of the mirror 416.

The optical power receiving system 450 illustrated in FIG. 4B has a structure in which the optical wireless communication transmitter (Tx) 452 is separated. The optical power receiving system 450 is a system capable of simultaneously enabling bi-directional optical wireless communication and optical power reception, and as illustrated in FIG. 4B, the optical signal λ3 transmitter (Tx) 452 for optical wireless communication and line-of-sight optical alignment is provided on the opposite side of a primary mirror 466. The optical signals λ1 and λ3, which are used for optical wireless communication and line-of-sight optical alignment, are transmitted through covers 412 and 462 via optical systems 406 and 456 and BFs 410 and 460 for collimated beam formation. In FIGS. 4A and 4B, it is preferable that the optical wireless communication optical signals λ1 and λ3 are transmitted through the

BFs 410 and 460 used in the optical wireless communication transmitters (Tx) 402 and 452, and a coating, a polarization or reflection structure, or a metasurface has properties of blocking the optical wireless power transmission light λ2 and harmful cosmic rays.

FIGS. 4A and 4B illustrate that the optical signals λ1 and λ3 and the optical wireless power transmission light λ2 for bi-directional optical wireless communication and line-of-sight optical alignment and dynamic tracking are transmitted and received through the same optical axis and optical path, as in the example of FIG. 3. However, unlike the above example of FIG. 3, there is an advantage in that the WDM filter for separating the transmitted and received light used for bi-directional optical wireless communication and line-of-sight optical alignment is not required, and the internal assembly of the optical wireless communication subsystem/optical alignment process and structure are simple.

Meanwhile, the secondary mirror used for bi-directional optical wireless communication and optical wireless power transmission and reception may have forms 318 and 368 separated from the system as illustrated in FIG. 3 or combined structures 418 and 468 as illustrated in FIGS. 4A and 4B.

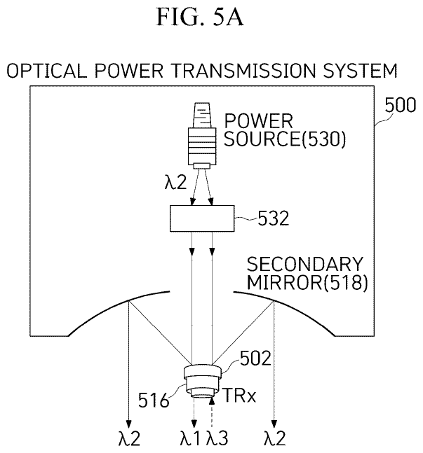

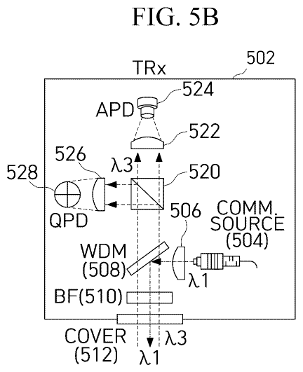

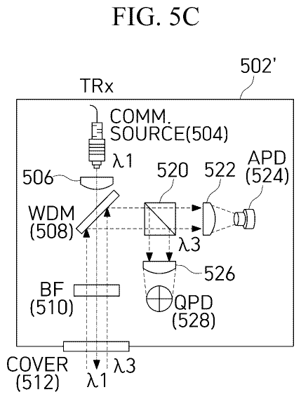

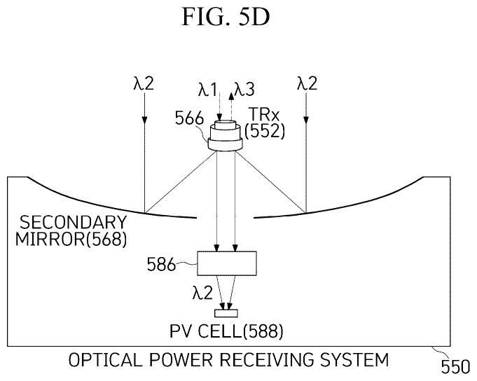

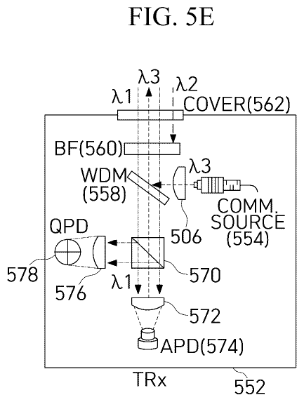

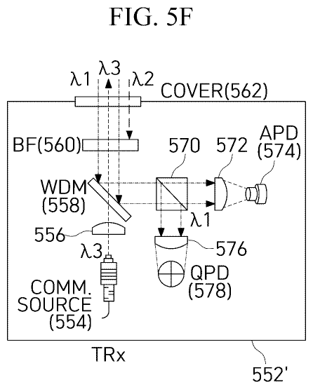

FIGS. 5A to 5F are structural diagrams of a unidirectional optical power transmission system in which an optical wireless communication subsystem is separated according to an embodiment of the present invention.

FIGS. 5A to 5F are diagrams illustrating an embodiment in which an optical wireless communication subsystem for simultaneously performing bi-directional communication and line-of-sight optical alignment and an optical wireless power transmission and receiving system are separated from each other.

Optical transceiver (TRx) subsystems 502, 502′, 552, and 552′ for bi-directional optical wireless communication and line-of-sight optical alignment and dynamic tracking are integrated on the opposite side of primary mirrors 516 and 566, and depending on the locations of optical wireless communication sources 504 and 554 and receiving optical devices ((APD) 524 and 574 and QPDs 528 and 578), the forms of an optical power transmission system 500 having the optical transceiver subsystems 502 and 502′ of FIGS. 5B or 5C or the optical power receiving system 550 having the optical transceiver subsystems 552 and 552′ of FIGS. 5E to 5F may be shown.

Similar to the embodiments of FIGS. 3 and 4, as in the structure (FIGS. 5A to 5F) of FIG. 5, the bi-directional optical wireless communication optical signals λ1 and λ3 and the light λ2 for optical wireless power transmission are transmitted through the same optical axis and common optical path. However, the structure of FIG. 5 is differentiated from the embodiments of FIGS. 3 and 4 described above in that the 45° tilted mirror with a hole structure is not used to separate the optical signal for optical wireless communication and the light for optical wireless power transmission inside the system.

In FIG. 5, the optical signals λ1 and λ3 transmitted to simultaneously perform bi-directional optical wireless communication and line-of-sight optical alignment come from communication sources 504 and 554 and are finally transmitted to the other party's system by sequentially passing through optical systems 506 and 556, WDM filters 508 and 558, and BFs 510 and 560 for collimated beam formation. The optical signals λ3 and λ1 received from the optical power transmission system 500 or the optical power receiving system 550 are incident on the APDs 524 and 574 and the QPDs 528 and 578 by sequentially passing through the BFs 510 and 560, the WDMs 508 and 558, and the BSs 520 and 570 and are used for data communication and precise line-of-sight optical alignment and dynamic tracking.

Here, as described above, the BFs 510 and 560 preferably have a coating, a polarization or reflection structure, or a metasurface to block the optical wireless power transmission light λ2 incident from the outside and harmful cosmic rays.

In addition, like the BFs 510 and 560, the covers 512 and 562 preferably have the function of transmitting the optical signals λ1 and λ3 and blocking the optical wireless power transmission light λ2 and cosmic rays.

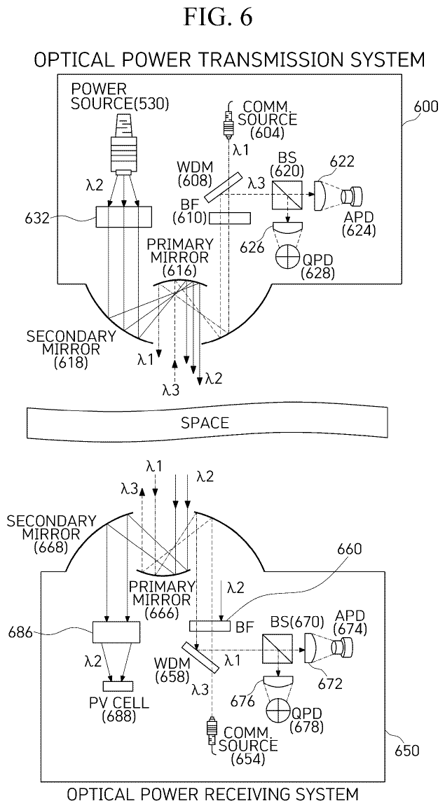

FIG. 6 is a diagram illustrating a change in system structure according to a change in shapes of a primary mirror and a secondary mirror.

As illustrated in FIG. 6, primary mirrors 616 and 666 and secondary mirrors 618 and 668 may be arranged in the opposite manner to the embodiments described above. As a result, contrary to the example described above, the light λ2 transmitted from an optical power transmission system 600 is reflected in the order of the secondary mirror 618 and the primary mirror 616 and is finally transmitted to tan optical power receiving system 650, and the light λ2 received by the optical power receiving system 650 is reflected in the order of the primary mirror 666 and the secondary mirror 668 and is incident into the system 650.

The primary mirrors 616 and 666 and the secondary mirrors 618 and 668 may have various shapes including parabolic, Cassegrain, Gregorian, convex, and concave, but are not limited thereto, and preferably have a structure that transmits the transmitted light over a long distance along the same optical axis through reflection or focuses the received light into the optical-to-electrical conversion device (PV cell), the APD/QPD, etc., and allows the received light to be incident.

FIG. 7 is a structural diagram of a bi-directional optical wireless communication and bi-directional optical power transmission system according to an embodiment of the present invention.

The bi-directional optical wireless communication and bi-directional optical power transmission system 70 according to an embodiment of the present invention is a system capable of simultaneously performing bi-directional optical wireless communication and bi-directional optical wireless power transmission.

FIG. 7 illustrates the structure of the system 20 for simultaneously performing bi-directional optical wireless power transmission and bi-directional optical wireless communication through switching control, as already described in FIG. 2.

Unlike the embodiment of FIG. 3, the system 70 according to the embodiment of FIG. 7 is characterized in that both optical power transceivers 700 and 750 have a configuration capable of transmitting and receiving optical wireless power. The two optical power transceivers 700 and 750 include power sources 730 and 780, optical-to-electrical conversion devices (PV cells 738 and 788), and reflective mirrors 734 and 784.

The reflective mirrors 734 and 784 can select optical wireless power transmission and reception functions through switching control such as a sliding operation and an open/close operation. The switching operation method is not limited to the examples described, and any method of selecting optical wireless power transmission and reception functions through physical operation and modification is possible.

In addition to FIG. 3, a structure capable of simultaneously performing bi-directional optical wireless power transmission and bi-directional optical wireless communication can be implemented by adding a power source, an optical-to-electrical conversion device, and a switchable reflective mirror to the optical power transceiver subsystems of FIGS. 4, 5, and 6.

A structure capable of simultaneously performing bi-directional optical wireless power transmission and bi-directional optical wireless communication is highly useful for establishing and operating an optical wireless power supply network that transmits produced or stored power to a system with insufficient power depending on the situation, as already described in FIG. 2.

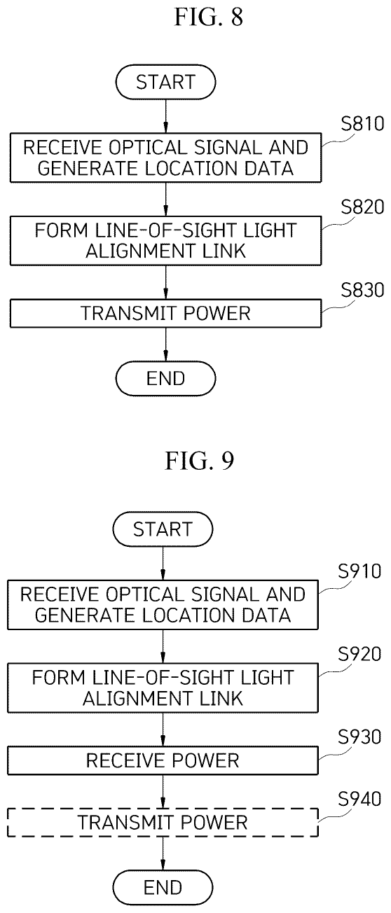

FIG. 8 is a flowchart for describing a method of operating an optical power transmission system according to an embodiment of the present invention.

The method of operating an optical power transmission system according to the embodiment of the present invention includes operations S810 to S830. The method of operating an optical power transmission system illustrated in FIG. 8 is according to one embodiment, and operations of the method of operating an optical power transmission system according to the present invention are not limited to the embodiment illustrated in FIG. 8, and may be added, changed, or deleted as needed.

Operation S810 is an operation of receiving an optical signal and generating location data. The optical wireless communication and tracking unit 113 causes the second optical signal λ3 transmitted from the optical power receiving system 120 to be incident on the optical-based location recognition sensor (QPD) to generate the location data for the second optical signal λ3. The location data includes normalized X data and normalized Y data.

Operation S820 is an operation of forming a line-of-sight optical alignment link. The integrated control unit 114 controls the steering unit 115 based on the location data to adjust the direction (angle) of the optical power transmission system 110 and form a line-of-sight optical alignment link between the optical power transmission system 110 and the optical power receiving system 120.

Operation S830 is an operation of transmitting power. The integrated control unit 114 determines whether the line-of-sight optical alignment link formed in operation S820 is precisely formed based on the QPD output data or the APD output data generated by the optical wireless communication and tracking unit 113 by the first optical signal λ3. When the integrated control unit 114 determines that the line-of-sight optical alignment link is precisely formed, the optical power transmitter 111 is controlled to transmit first power transmission light to the optical power receiving system 120 through the same optical path as the line-of-sight optical alignment link. The optical power transmitter 111 generates the first power transmission light λ2 by electrical-to-optical conversion of the power pre-stored in the power storage unit 116 under the control of the integrated control unit 114 and transmits the first power transmission light λ2 to the optical power receiving system 120 in an optical wireless manner through the same optical path as the line-of-sight optical alignment link. When the integrated control unit 114 determines that the line-of-sight optical alignment link is not precisely formed, the integrated control unit 114 controls the steering unit 115 based on the location data to correct the line-of-sight optical alignment link or stop transmitting power.

FIG. 9 is a flowchart illustrating a method of operating an optical power receiving system according to an embodiment of the present invention.

The method of operating an optical power receiving system according to the embodiment of the present invention includes operations S910 to S930. The method of operating an optical power receiving system illustrated in FIG. 9 is according to one embodiment, and operations of the method of operating an optical power receiving system according to the present invention are not limited to the embodiment illustrated in FIG. 9, and may be added, changed, or deleted as needed. For example, as illustrated in FIG. 9, operation S940 may be added to the above operation method.

Operation S910 is an operation of receiving an optical signal and generating location data. The optical wireless communication and tracking unit 123 causes the first optical signal λ1 transmitted from the optical power transmission system 110 to be incident on the optical-based location recognition sensor (QPD) to detect the location data for the first optical signal λ1. The location data includes normalized X data and normalized Y data.

Operation S920 is an operation of forming a line-of-sight optical alignment link. The integrated control unit 124 controls the steering unit 125 based on the location data to adjust the direction (angle) of the optical power receiving system 120 and form a line-of-sight optical alignment link between the optical power transmission system 110 and the optical power receiving system 120.

Operation S930 is an operation of receiving power. The integrated control unit 124 determines whether the line-of-sight optical alignment link formed in operation S920 is precisely formed based on the QPD output data or the APD output data generated by the optical wireless communication and tracking unit 123 by the first optical signal λ1. When the integrated control unit 124 determines that the line-of-sight optical alignment link is precisely formed, the integrated control unit 124 controls the optical power receiver 122 to receive the first power transmission light λ2 transmitted by the optical power transmission system 110 through the same optical path as the line-of-sight optical alignment link. The optical power receiver 122 converts the first power transmission light λ2 into power and stores the power in the power storage unit 126.

When the integrated control unit 124 determines that the line-of-sight optical alignment link is not precisely formed, the integrated control unit 124 controls the steering unit 125 based on the location data to correct the line-of-sight optical alignment link or stop receiving power.

Operation S940 is an operation of transmitting power. This operation is an operation that may be performed when the optical power receiving system 120 further includes an optical power transmitter 121 (not illustrated). The optical power transmitter 121 has the same configuration and function as the optical power transmitter 211 of FIG. 2. The optical power receiving system 120, which further includes the optical power transmitter 121, has the same configuration as the optical power transceivers 210 and 220 illustrated in FIG. 2.

The integrated control unit 124 determines a power transmission target through communication with the optical power transmission system 110 or another optical power receiving system. For example, the power transmission target may be the optical power transmission system 110 or another optical power receiving system.

The integrated control unit 124 forms a line-of-sight optical alignment link with the power transmission target through the same procedure as operations S910 and S920.

The optical power transmitter 121 generates second power transmission light λ4 by electrical-to-optical conversion of the power pre-stored in the power storage unit 126 under the control of the integrated control unit 124 and transmits the second power transmission light λ4 to the power transmission target system in an optical wireless manner through the same optical path as the line-of-sight optical alignment link formed for the power transmission target.

The above-described method of operating an optical power transmission system and method of operating an optical power receiving system were described with reference to the flowcharts illustrated in FIGS. 8 and 9. For simplicity, the methods have been illustrated and described as a series of blocks, but the present invention is not limited to the order of the blocks, and some blocks may occur with other blocks in a different order or at the same time as illustrated and described in the present specification. Also, various other branches, flow paths, and orders of blocks that achieve the same or similar results may be implemented. In addition, all the illustrated blocks may be not required for implementation of the methods described in the present specification.

Meanwhile, in the description with reference to FIGS. 8 and 9, each operation may be further divided into additional operations or combined into fewer operations according to an implementation example of the present invention. Also, some operations may be omitted if necessary, and the order between operations may be changed. In addition, the content of FIGS. 1 to 7 may be applied to the content of FIGS. 8 and 9 even if other content is omitted. Also, the content of FIGS. 8 and 9 may be applied to the content of FIGS. 1 to 7.

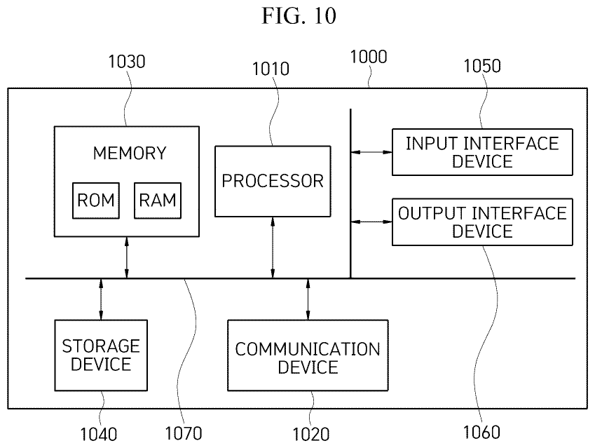

FIG. 10 is a block diagram illustrating a computer system for implementing the method according to the embodiment of the present invention. The optical wireless communication and tracking units 113, 123, 213, and 223 or the integrated control units 114, 124, 214, and 224 illustrated in FIGS. 1 and 2 may include the computer system illustrated in FIG. 10 to perform the operations of calculating QPD output data, etc., determining the precision of line-of-sight optical alignment, generating control commands, etc.

Referring to FIG. 10, a computer system 1000 may include at least one of a processor 1010, a memory 1030, an input interface device 1050, an output interface device 1060, and a storage device 1040 that communicate with each other through a bus 1070. The computer system 1000 may further include a communication device 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random access memory (RAM). In the embodiment of the present invention, the memory may be located inside or outside the processor, and the memory may be connected to the processor through various known means. The memory may include various types of volatile or non-volatile storage media, and the memory may include, for example, a ROM or a RAM.

Accordingly, embodiments of the present invention may be implemented as a computer-implemented method, or as a non-transitory computer-readable medium storing computer-executable instructions. In one embodiment, when executed by the processor, the computer-readable instructions may perform a method according to at least one aspect of the present invention.

The communication device 1020 may transmit or receive a wired signal or a wireless signal.

In addition, the method according to the embodiment of the present invention may be implemented in a form of program instructions that may be executed through various computer means and may be recorded on a computer-readable recording medium.

The computer-readable recording medium may include a program instruction, a data file, a data structure or the like, alone or in combination. The program instructions recorded on the computer-readable recording medium may be specially designed and configured for embodiments of the present invention, or may be known and used by those skilled in the field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disc read only memory (CD-ROM) or a digital versatile disc (DVD), magneto-optical media such as a floptical disk, a ROM, a RAM, a flash memory, or the like. Examples of the program instructions may include high-level language code capable of being executed by a computer using an interpreter, or the like, as well as machine language code made by a compiler.

Although exemplary embodiments of the present invention have been disclosed above, it should be understood by those skilled in the art that the present invention may be variously modified and altered without departing from the scope and spirit of the present invention described in the following claims. For example, a person skilled in the art to which the present invention pertains may use the configurations disclosed in FIGS. 3 to 7 to implement the bi-directional optical wireless communication and unidirectional optical power transmission system 10 illustrated in FIG. 1 or the bi-directional optical wireless communication and bi-directional optical power transmission system 20 illustrated in FIG. 2.

What is claimed is:

1. An optical power receiving system comprising:
an optical wireless communication and tracking unit that causes a first optical signal transmitted from an optical power transmission system to be incident on an optical-based location recognition sensor to generate location data for the first optical signal;
a steering unit that changes an orientation of the optical power receiving system;
an integrated control unit that controls the steering unit based on the location data to form a line-of-sight optical alignment link for the optical power transmission system; and
an optical power receiver that receives first power transmission light transmitted in an optical wireless manner by the optical power transmission system through the same optical path as the line-of-sight optical alignment link.

2. The optical power receiving system of claim 1, wherein the optical wireless communication and tracking unit performs optical wireless communication with the optical power transmission system through the same optical path as the line-of-sight optical alignment link.

3. The optical power receiving system of claim 1, wherein the optical wireless communication and tracking unit transmits a second optical signal to the optical power transmission system in an optical wireless manner so that the optical power transmission system performs line-of-sight optical alignment for the optical power receiving system using the second optical signal.

4. The optical power receiving system of claim 1, wherein the optical-based location recognition sensor is a quadrant photodiode (QPD).

5. The optical power receiving system of claim 4, wherein the optical wireless communication and tracking unit acquires QPD output data for the first optical signal from the QPD, and calculates normalized X data and normalized Y data based on the QPD output data and generates the location data including the normalized X data and the normalized Y data.

6. The optical power receiving system of claim 5, wherein the integrated control unit determines whether the line-of-sight optical alignment link is precisely formed based on whether the QPD output data is greater than or equal to a predetermined threshold and controls the optical power receiver to receive the first power transmission light through the same optical path as the line-of-sight optical alignment link when it is determined that the line-of-sight optical alignment link is precisely formed.

7. The optical power receiving system of claim 6, wherein the integrated control unit controls the steering unit based on the location data to correct the line-of-sight optical alignment link when it is determined that the line-of-sight optical alignment link is not precisely formed.

8. The optical power receiving system of claim 1, wherein the optical wireless communication and tracking unit causes the first optical signal to be incident on an avalanche photodiode (APD) to generate APD output data for the first optical signal, and
the integrated control unit determines whether the line-of-sight optical alignment link is precisely formed based on whether the APD output data is greater than or equal to a predetermined threshold and controls the optical power receiver to receive the first power transmission light through the same optical path as the line-of-sight optical alignment link when it is determined that the line-of-sight optical alignment link is precisely formed.

9. The optical power receiving system of claim 1, further comprising, inside the optical power receiving system, a 45° tilted mirror with a hole structure to separate paths of the first optical signal and the first power transmission light.

10. The optical power receiving system of claim 1, further comprising a power storage unit and an optical power transmitter,
wherein the optical power receiver converts the first power transmission light into power and stores the power in the power storage unit, and
the optical power transmitter generates second power transmission light through electrical-to-optical conversion of the power stored in the power storage unit and transmits the second power transmission light to another optical power receiving system.

11. An optical power transmission system comprising:
a power storage unit that stores power received externally;
an optical wireless communication and tracking unit that causes a second optical signal transmitted from an optical power receiving system to be incident on an optical-based location recognition sensor to generate location data for the second optical signal;
a steering unit that changes an orientation of the optical power transmission system;
an integrated control unit that controls the steering unit based on the location data to form a line-of-sight optical alignment link for the optical power receiving system; and
an optical power transmitter that generates first power transmission light through electrical-to-optical conversion of the power stored in the power storage unit and transmits the first power transmission light to the optical power receiving system in an optical wireless manner through the same optical path as the line-of-sight optical alignment link.

12. The optical power transmission system of claim 11, wherein the optical wireless communication and tracking unit performs optical wireless communication with the optical power receiving system through the same optical path as the line-of-sight optical alignment link.

13. The optical power transmission system of claim 11, wherein the optical wireless communication and tracking unit generates a first optical signal using an optical wireless communication source and transmits the first optical signal to the optical power receiving system in an optical wireless manner so that the optical power receiving system performs line-of-sight optical alignment for the optical power transmission system using the first optical signal.

14. The optical power transmission system of claim 11, wherein the optical-based location recognition sensor is a quadrant photodiode (QPD).

15. The optical power transmission system of claim 14, wherein the optical wireless communication and tracking unit acquires QPD output data for the second optical signal from the QPD, and
calculates normalized X data and normalized Y data based on the QPD output data and generates the location data including the normalized X data and the normalized Y data.

16. The optical power transmission system of claim 15, wherein the integrated control unit determines whether the line-of-sight optical alignment link is precisely formed based on whether the QPD output data is greater than or equal to a predetermined threshold and controls the optical power transmitter to transmit the first power transmission light through the same optical path as the line-of-sight optical alignment link when it is determined that the line-of-sight optical alignment link is precisely formed.

17. The optical power transmission system of claim 16, wherein the integrated control unit controls the steering unit based on the location data to correct the line-of- sight optical alignment link when it is determined that the line-of-sight optical alignment link is not precisely formed.

18. The optical power transmission system of claim 11, wherein the optical wireless communication and tracking unit causes the second optical signal to be incident on an avalanche photodiode (APD) to generate APD output data for the second optical signal, and
the integrated control unit determines whether the line-of-sight optical alignment link is precisely formed based on whether the APD output data is greater than or equal to a predetermined threshold and controls the optical power transmitter to transmit the first power transmission light through the same optical path as the line-of-sight optical alignment link when it is determined that the line-of-sight optical alignment link is precisely formed.

19. The optical power transmission system of claim 13, further comprising, inside the optical power transmission system, a 45° tilted mirror with a hole structure that is disposed to transmit the first power transmission light and the first optical signal incident in a direction perpendicular to an incident direction of the first power transmission light to the optical power receiving system through the same optical path as the line-of-sight optical alignment link.

20. A method of operating an optical power transmission system, comprising:
causing a second optical signal transmitted from an optical power receiving system to be incident on an optical-based location recognition sensor to generate location data for the second optical signal;
adjusting an orientation of the optical power transmission system based on the location data to form a line-of-sight optical alignment link between the optical power transmission system and the optical power receiving system; and
generating first power transmission light by electrical-to-optical conversion of pre-stored power and transmitting the first power transmission light to the optical power receiving system in an optical wireless manner through the same optical path as the line-of-sight optical alignment link.
